(19) United States
(12) Patent Application Publication
(10) Pub. No.: US 2004/0215394 A1
(43) Pub. Date: Oct. 28, 2004

(54) Method and apparatus for advanced prediction of changes in a global weather forecast

(76) Inventors: Richard Lee Carpenter JR., Norman, OK (US); Gene Marcel Bassett, Norman, OK (US); David L. Montroy, Owasso, OK (US)

Correspondence Address: COOLEY GODWARD, LLP, 3000 EL CAMINO REAL, 5 PALO ALTO SQUARE, PALO ALTO, CA, 94306, US

(21) Appl. No.: 10/455,269

(22) Filed: Jun. 4, 2003

Related U.S. Application Data
(60) Provisional application No. 60/465,331, filed on Apr. 24, 2003.

(51) Int. Cl. G06F 169/00

(52) U.S. Cl. 702/3

(57) ABSTRACT

A method for generating an accelerated global coverage weather model is disclosed by storing an existing full resolution, global coverage weather model output data in the memory of a computer. Global weather observation data is then received for less than a mandated observation period and compiled into the computer memory. An accelerated global coverage weather model output is generated based in part on the existing, full resolution, global coverage weather model data and the received weather observation data.

### CROSS REFERENCE TO RELATED APPLICATION

This application claims benefit under 35 U.S.C. 119 (e) to U.S. Provisional Application No. 60/465,331 entitled “METHOD AND APPARATUS FOR ADVANCED PREDICTION OF CHANGES IN A GLOBAL WEATHER FORECAST” filed May 24, 2003, which is incorporated herein by reference in its entirety.

### FIELD OF THE INVENTION

The present invention relates generally to processing global coverage numerical weather models. More particularly, this invention relates to techniques for advanced prediction of changes in a global coverage numerical weather model.

### BACKGROUND OF THE INVENTION

Weather forecasts, either generated by the government or based on meteorological data collected by the government, are routinely used by energy and commodity trading organizations to establish trading positions. In the United States, the National Centers for Environmental Research (NCEP) runs the Global Forecast System (GFS), which provides weather forecast information four times a day for a forecast period of 16 days. In April 2002, the NCEP Medium Range Forecast (MRF) and Aviation (AVN) forecasts were replaced by the GFS.

The global forecast system relies on global weather observation data. For purposes of generating numerical weather forecasts, most weather observation data are collected every six hours and transmitted to NCEP. Using the newly collected weather observations, the GFS model is run, and the weather forecast updated as needed. As would be expected, changes in the weather forecast and the impact of the changes may have a dramatic impact on energy and commodity traders.

Because NCEP releases its revised forecast periodically during the forecast period, most traders receive the forecast information at the same time. Traders are therefore under increased time pressure to collect and analyze forecast data as soon as it is available so that they may change their trading position based on their believed impact of the updated weather forecast information. It would be highly desirable to have a predictive tool that would provide likely changes in the NCEP forecast. The output of the predictive tool would be available before the NCEP forecast becomes available, thereby providing traders with access to the predictive tool a significant time advantage.

### SUMMARY OF THE INVENTION

In accordance with the objects outlined above, one embodiment of the present invention provides a numerical weather model generation method executed by a computer under the control of a program that includes storing an existing full resolution global coverage weather model in a memory. Receiving a plurality of global weather observation data for less than a mandated observation period and then compiling the received weather observation data in the memory with the stored existing full resolution global coverage weather model to represent conditions in the atmosphere. Next, generating an accelerated global coverage weather model for an extended forecast period based in part on the received weather observation data using a resolution value less detailed than a resolution value used to generate the existing full resolution global coverage weather model.

In another embodiment of the present invention there is provided a method of determining likely changes in a forecast weather model executed by a computer under the control of a program. The method includes storing an existing full resolution global coverage weather model in a memory. Then, receiving weather observation data from a plurality of globally located weather observation points for less than a mandated observation period. Next, generating a numerical representation of atmospheric conditions based on the received weather observation data and the full resolution global coverage weather model and then, generating an accelerated global coverage weather model for an extended forecast period based in part on the generated numerical representation of the atmospheric conditions. This generating is performed while using a resolution value less than a resolution value used to generate the existing full resolution global coverage weather model. Next, compare the accelerated global coverage weather model to the existing full resolution global coverage weather model. Based on the comparison, generate a report representing the likely changes in the full resolution global coverage weather model.

In another embodiment of the present invention there is provided a computer readable medium that includes executable instructions to generate a displayed geographic location. In addition, there is provided executable instructions to generate a forecast duration having a plurality of subdivided time periods. For the geographic location during each of the subdivided time periods there is also provided at least one of a computer generated visual indication of an increase in a forecast variable, a computer generated visual indication of a decrease in a forecast variable, a computer generated visual indication of the magnitude of an increase in a forecast variable, and a computer generated visual indication of the magnitude of a decrease in a forecast variable.

In another embodiment of the present invention, there is provided a method for determining a trading position in a financial market. In this embodiment, generate a computer-based accelerated global coverage weather model of a full resolution global coverage weather model. Here, the full resolution global coverage weather model represents the index of market consensus for the weather forecast. Next, produce an output representing the likely changes in the full resolution global coverage weather model by comparing the accelerated global coverage weather model to the full resolution global coverage weather model. Thereafter, adjust a trading position of a trading instrument based upon the output representing the likely changes in the full resolution global coverage weather model.

### BRIEF DESCRIPTION OF THE DRAWINGS

For a better understanding of the invention, reference should be made to the following detailed description taken in conjunction with the following drawings, in which:

FIG. 1 illustrates a general purpose computer configured to generate full resolution weather models.

FIG. 2 illustrates a process flow to generate full resolution weather models.

FIG. 3 illustrates a general purpose computer configured to execute the invention.

FIG. 4 illustrates a process flow of a numerical weather model generated according to an embodiment of the invention.

FIG. 5 illustrates processing executed by the apparatus of FIG. 3

FIGS. 6A and 6B compare model resolution and model availability for NCEP generated models and models generated according to an embodiment of the invention.

FIG. 7 is a representative graphical user interface for displaying outputs generated by embodiments of the invention.

FIG. 8A illustrates a graphical output 6 day forecast of 500 mb height and vorticity generated by an embodiment of the present invention.

FIG. 8B illustrates a graphical output 6 day forecast of 500 mb height and vorticity generated by NCEP.

FIG. 9A illustrates a graphical output 6 day forecast of precipitation and 1000-500 mb thickness generated by an embodiment of the present invention.

FIG. 9B illustrates a graphical output 6 day forecast of precipitation and 1000-500 mb thickness generated by NCEP.

FIGS. 10A. through 10D are illustrative embodiments of a report representing likely changes for a full resolution global coverage weather model.

### DETAILED DESCRIPTION OF THE INVENTION

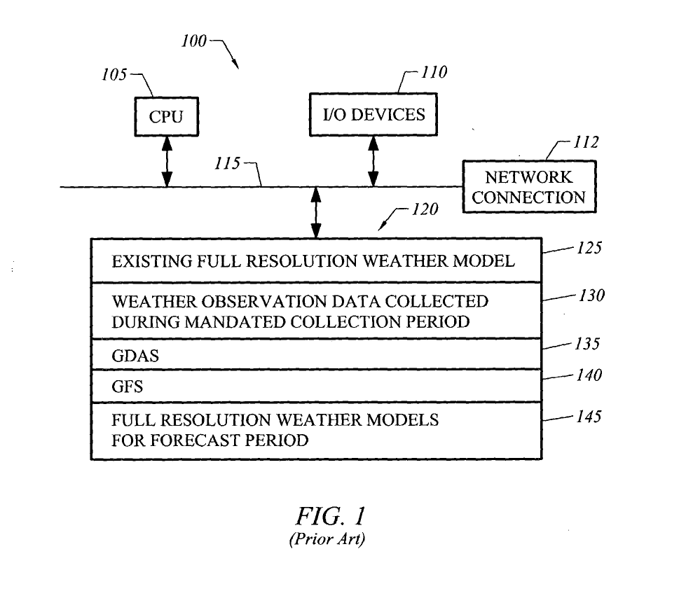

FIG. 1 illustrates a prior art general purpose computer 100 constructed to generate full resolution global coverage weather models. The computer 100 includes one or more central processing units (CPU) 105, which communicate with a set of input/output (I/O) devices 110 over a bus 115. The I/O devices 110 may include a keyboard, mouse, video monitor, printer, etc. The CPU 105 also communicates with a memory 120 over the bus 115. The network connection 112 is also provided to allow communication between the computer 100 and other computers or computer networks. Network connection 112 allows access to LANs, WANs the Internet or other private and public networks. The interaction between CPU 105, I/O devices 110, bus 115 and memory 120 are well known in the art.

While FIG. 1 illustrates the overall structure of a system used to generate full resolution, global coverage weather models, further description of the CPU 105 and computer 100 are needed. Given the complexity and resolution needed in present day global coverage numerical weather models, substantial computer processing power is required for near real time weather model generation. According to the Progress Report on the Global Data Processing System 2001 provided by NCEP, the NCEP full resolution numerical weather models are generated using an IBM RS/6000 SP. This system utilizes the AIX operating system with 2336 Power 3 Winterhawk II CPUs, 1168 GB of memory, and more than 14 TB of disk storage. The complete report is available at www.wmo.ch/web/www/DPS/GDPS—Reports—2001-2/ncep-2001.doc, and is incorporated by reference herein in its entirety.

Continuing with FIG. 1, the memory 120 also stores an earlier generated global coverage full resolution weather model output data 125, weather observation data collected during a mandated observation period 130, the Global Data Acquisition System (GDAS) 135, the Global Forecasting System (GFS) 140, and full resolution, global coverage weather model output data 145 for the forecast period. The earlier generated full resolution weather model 125, weather observation data 130, GDAS 135 and GFS 140 are further described below. Additional information regarding the GFS and GDAS is available from the NCEP Global Climate and Weather Modeling Branch at http://www.emc.ncep.noaa.gov/gmb.

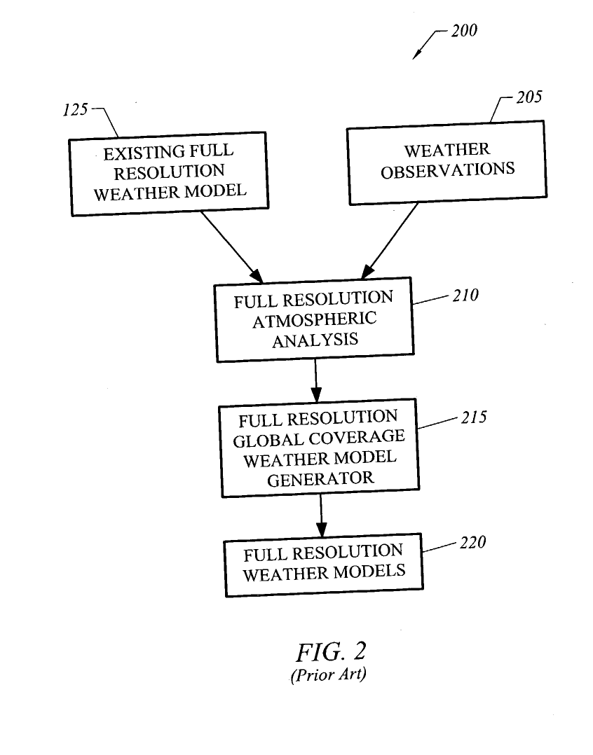

Attention is now directed to FIG. 2. FIG. 2 illustrates a prior art process flow 200 used to generate global coverage full resolution numerical weather models. FIG. 2 illustrates the sequence of events of the processing performed in FIG. 1. To improve understanding of the following description, the reader may wish to refer to FIG. 1 and FIG. 2 together.

Weather stems from the constant evolution of the atmosphere governed by physical laws. Using high-speed computers to solve a complex set of mathematical equations that represents the governing laws, numerical weather prediction is a technique for simulating the atmospheric evolution in order to delineate the resultant weather changes. The variables involved in the equations include, for example, wind, temperature, pressure and moisture content. Accordingly, the atmospheric variables can be numerically solved as functions of time and form the basis of a weather forecast. Two of the most commonly used numerical methods include “spectral transform method” and “finite difference method.” The corresponding numerical weather models are often referred to as “spectral models” and “finite difference models”, respectively. For spectral models, the computational array is wave number. Spectral model resolution may be adjusted by increasing or decreasing the number of waves used. For finite difference models, the computational array used is grid points. Finite difference model resolution may be adjusted by increasing or decreasing grid point spacing. Vertical spacing for both spectral models and finite difference models may be adjusted by increasing or decreasing the number of vertical layers used to approximate the atmosphere. The computational array used for a particular model is referred to as the native grid for that model.

Numerical weather models have been in use since the grid point primitive equation (PE) model of the 1960s. The global spectral model replaced the PE model in 1981. The predecessor of the GFS was the Aviation (AVN) and Medium Range Forecast (MRF) introduced in 1985 as an upgrade to the global spectral model. Originally the AVN/MRF model had a rhomboidal truncation (R) at 40 waves (R40), with 18 vertical levels (L18), and made a 168-hr forecast. Improvements in both horizontal and vertical resolution and increases in forecast length have come as computational resources have increased. In 1988, the model was changed from rhomboidal to triangular truncation (T) at 80 waves (T80) in a major upgrade. In 1991, the number of waves was increased from 80 to 126. The horizontal resolution remained at the T126 level until mid-January 2000. At that time, the number of waves used in spectral calculations was increased from T126 (roughly 2.9°/105 km) to T170 (roughly 2.1°/80 km) for the first 180 hours of the forecast. In early 2002, the MRF run of the global forecast system (GFS) was discontinued, and the AVN runs were increased in forecast length out to 384 hours. The current GFS forecast model replaces the AVN/MRF forecast models. The current GFS medium range forecast model was increased to T254 (roughly 1.6°/55 km) horizontal resolution for the first 84 hours of the forecast on Oct. 29, 2002.

Returning to FIG. 2, weather models rely on the weather observation data (130) collected during weather observations (205) to remain current. Weather observation data is received from a plurality of globally located weather observation points, including a wide array of both satellite based and non-satellite based weather observation data (130) sources. Representative categories of satellite based weather observation sources are satellite soundings, satellite winds, satellite surface and Advanced TIROS Operational Vertical Sounder (ATOVS). Representative categories of non-satellite observation sources include land surface, marine surface, land soundings and aircraft based sensors. In 2001, the average daily data counts for non-satellite weather observation sources was 290,903 and the average daily data counts for satellite weather observation sources was 1,877,972. A further breakdown of the data subcategories is available in the Progress Report on the Global Data Processing System 2001 (see above). In addition, weather observation data 130 are collected by various national meteorological centers around the world and transmitted via global telecommunication networks to NCEP. The observation data 130 is converted to the WMO BUFR format for use by GDAS. Additional information regarding the WMO BUFR file format can be found at http://www.wmo.ch/web/www/WDM/Guides/BUFR-CREX-guide.html.

Numerical weather models are unable to continuously take in new observation data. During every forecast cycle, weather observations 205 are made and observation data 130 is transmitted back, in the United States, to NCEP. It takes a certain amount of time for observations to be made, the data to be collected and the collected data to be transmitted.

During the regular forecast cycle there is a nominal observation time or valid time of the forecast. A valid observation time period exists about the nominal observation time during which observation data is accepted. For example, for the 1200 GMT GFS forecast, the nominal observation time or valid time for the forecast is 1200 GMT. NCEP generally provides a six hour valid observation time period for each forecast (i.e., plus or minus three hours of the nominal observation time). As such, an observation recorded transmitted and received by NCEP during a time period from 0900 GMT to 1500 GMT, would be valid for the 1200 GMT nominal observation time for that forecast day. In this manner, observations that are transmitted late or are otherwise not timely received during the valid observation time period will not be used during that forecast cycle. Generally, observations for a particular nominal observation time are received before, at and after the nominal observation time. As a result, there is a distribution of the number of observations received during the nominal observation time period about the nominal observation time. During a typical forecast cycle, the number of observations received generally increases during the observation time period before the nominal observation time. The most observations are received during a time period about the nominal observation time, for example, a two hour time period during the valid observation time period and centered on the nominal observation time. The number of observations received is generally decreasing after the nominal observation time. In general, for a given forecast cycle, the number of observations received increases before the nominal observation time, reaches a peak during a time period about the nominal observation time, and then decreases until the end of the valid observation time for that forecast cycle.

Increased weather observation data collection time results in more accurate weather model generation. A tension exists, however, for weather models to be generated on a regular schedule in near real time. For this reason, a stopping point must be established that signifies the end of the waiting for weather observation data to be collected and transmitted. The term “data cut off” refers to that stopping point. Models assimilate all of the data that was taken in up to “data cut off” and create a “run”. Each model run has its own data cut off and schedule. For a given full resolution weather model during a given weather forecast cycle, weather observation data will be collected during a mandated collection period. The mandated collection period refers to the data cut off point for that model for that forecast cycle. The mandated collection period is always within the valid observation time period for a particular forecast.

A number of variables are used to determine the resolution of a weather model. One variable relates to the number of weather observations used to generate the model. In general, a longer data cut off period allows for a greater number of observations to be used simply because by waiting, more time is given for observations to the made, recorded and transmitted. Long data cut off times or cut off times greater than two hours are typical of full resolution global coverage weather models. Another variable used to define model resolution is the type of observation data used to generate a weather model. As described above, a number of both satellite and non-satellite observation sources are available. The use of the wide variety of both satellite and non-satellite observation sources is another characteristic of full resolution global coverage weather models. Another variable used to define model resolution is the computational array resolution. The computational array of a spectral model includes wave number and vertical layers. A full resolution spectral model would use increased or higher resolution that in this case means either higher wave numbers, or more vertical layers, or both. The computational array of a finite difference or grid point model includes grid point spacing and vertical layers. A full resolution finite difference model would use increased or higher resolution that in this case means either smaller grid point spacing, or more vertical layers, or both.

Given the complexity of modern weather models, it is common to use an earlier generated weather model as the basis for generating an updated weather model. An existing full resolution global weather model data output (125) is created by an earlier weather model forecasting cycle. In terms of present day, spectral weather models, this earlier generated model is used as the computational array for the next weather model cycle.

Against that backdrop of the incoming volume of live weather observation data (130) and earlier generated full resolution weather model output data (125), a full resolution analysis of the atmosphere is performed (210) in preparation for running a full resolution global coverage weather model generator 215. For full resolution weather models generated in the United States, the Global Data Assimilation System (GDAS) 135 is used to perform the atmospheric analysis (210). The GDAS 135 is a computer program that generates a numerical analysis of the atmosphere that is used to start the full resolution global coverage weather model generator 215. For full resolution weather models generated in the United States, the full resolution global coverage weather model generator 215 is the Global Forecasting System (GFS) 140. The output of the GDAS 135, earlier generated full resolution weather model output data 125, and the input/output of the GFS 140 are in a non-standard binary format.

Global data assimilation for the GFS 140 is done using a multi-variate Spectral Statistical Interpolation (SSI) analysis scheme using a 3-dimensional variational technique in which a linear balance constraint is incorporated. The analyzed variables are the associated Legendre spectral coefficients of temperature, vorticity, divergence, water vapor mixing ratio and the natural logarithm of surface pressure. During a given forecast day, weather observations are taken, in most cases, every 6 hours to correspond to the daily weather forecasts. In the United States, the NCEP GFS model runs are conducted at 0000, 0600, 1200 and 1800 Times listed may be either Greenwich Mean Time (GMT) or Universal Coordinated Time (UTC). The corresponding data cut off time for each of the daily NCEP GDAS operations are 0245, 0845, 1445 and 2045 respectively. The mandated observational data collection period is currently 2 hours and 45 minutes. This means that the NCEP GDAS will gather observational data for 2 hours and 45 minutes before performing the analysis used to initiate the corresponding NCEP GFS run.

The Global Forecast Model (GFS) 140 is a computer program used to generate a plurality of high resolution global coverage numerical weather models during a given forecast period. The GFS uses the spectral method for its dynamic calculations. The forecast variables virtual temperature (Tᵥ), vorticity and divergence, surface pressure (p_{sfc}), specific humidity (q), and ozone are calculated using a triangular truncation at 254 waves (T254), 170 waves (T170) or 126 waves (T126) during the NCEP GFS forecast. Initially, the NCEP GFS utilizes a resolution with triangular truncation at 254 waves (T254). T254 means that the smallest wave used to describe the horizontal distribution of the forecast variables has a wavelength of about 1.4°, or roughly equivalent to a 55-km horizontal grid spacing. This resolution remains until 84 hours in the forecast period. At 84 hours, the model is truncated at a coarser resolution and run at triangular truncation with 170 waves (T170) to 180 hours. Finally, the model is run at 126 waves (T26) from 180 hours to the end of the forecast period. The smallest horizontal wave used to describe the forecast variables at T126 truncation is about 2.9°.

The GFS 140 has the associated Legendre coefficients of natural logarithm of surface pressure, temperature, vorticity, divergence, water vapor mixing ratio and cloud water/ice as its prognostic variables. The vertical domain includes the surface to 2 mb and is discretized with numerous sigma layers. The Legendre series for all variables are truncated (triangular) at several levels. The resolution of the NCEP GFS model has increased recently. In 2000, the NCEP GFS model increased from a “high resolution” of T126 to T170. Currently, “high resolution” models are truncated at 254 waves or T254. The number of vertical layers represented in the model has also increased. In 2001, 42 sigma levels for vertical resolution was considered “high resolution.” Currently, “high resolution” includes vertical resolution for 64 sigma levels. Model resolution or computational array resolution as part of the more general resolution described above herein refers to both the horizontal (T) and vertical (L) components of the computational array of a model. The model resolution of a given spectral model is normally expressed as a truncation level (T) and a sigma level (L). For example, the highest resolution models generated today are T254L64 which means a horizontal truncation of 254 waves with 64 sigma levels of vertical resolution. Current “medium resolution” models are T170L42 and “low resolution” models are T126L28. The relative degrees of resolution of a given numerical weather model have changed in the past as described above and are expected to change in the future. Embodiments of the present invention are described herein in terms of present computational array resolution standards. As will be seen in the discussion that follows, the present invention is equally applicable to numerical weather models at future resolution levels as well.

Returning to FIG. 2, the output of the full resolution global coverage weather model generator 215 (e.g., NCEP GFS 140) is a full resolution weather model output 220. The numerical values for the weather models are stored as data in the form of full resolution weather model output data 145 for the forecast period. The model includes a full set of parameterizations for physical processes, including moist convection, cloud-radiation interactions, stability dependent vertical diffusion, evaporation of falling rain, similarity theory derived boundary layer processes, hard surface vegetation effects, surface hydrology and horizontal diffusion.

The description above with regard to FIG. 2 provides the general processes used by NCEP to systematically produce numerical model weather forecasts. For example, the GFS forecast is produced four times a day at 0000, 0600, 1200 and 1800 GMT. For each of these model runs, forecasts are generated for a 16 day forecast period at a variety of resolution levels. Currently, NCEP provides a “high” T254L64 resolution forecast for the first 84 hours or 3.5 days. The model is then truncated to a coarser resolution or a “medium” T170L42 resolution forecast out to 180 hours or 7.5 days. Thereafter, the model resolution is truncated again to a “low” T126L28 resolution for the remainder of the forecast period. The GDAS 135 data cut off times are about two hours and 45 minutes after the start of the model run time. For example, data cut off of 0245, 0845, 1445 and 2045 are used, respectively, for the 0000, 0600, 1200 and 1800 NCEP GFS analyses. Specific data cut off and model simulation times used are reported by NCEP in a report entitled “CURRENT STATUS OF THE NCEP PRODUCTION SUITE” available at the following web site: http://www.nco.ncep.noaa.gov/pmb/nwprod/prodstat, the entire contents of which is incorporated herein by reference.

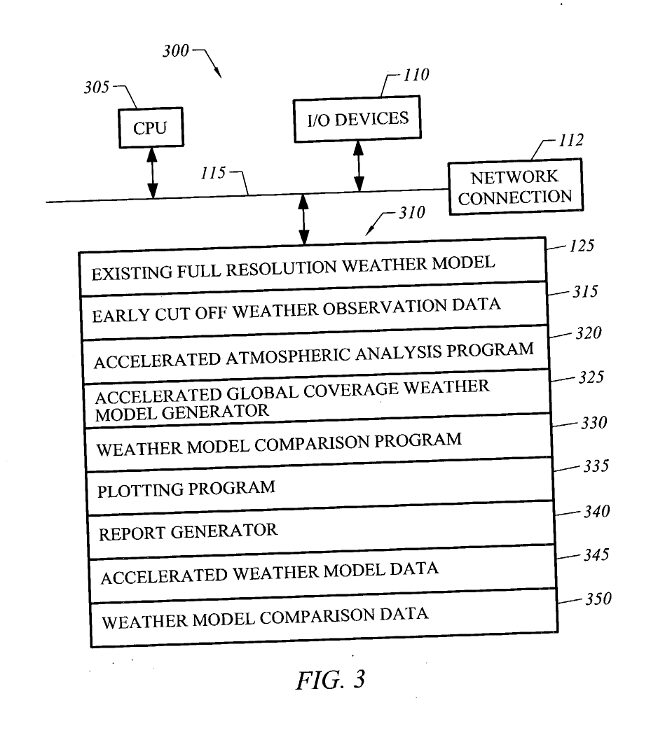

FIG. 3 illustrates a general purpose computer 300 constructed to implement the present invention. The computer 300 includes one or more central processing units (CPU) 305, which communicate with a set of input/output (I/O) devices 110 over a bus 115. The I/O devices 110 may include a keyboard, mouse, video monitor, printer, etc. The CPU 305 also communicates with a memory 310 over the bus 115. The interaction between CPU 305, I/O devices 110, bus 115 and memory 310 are well known in the art. The network connection 112 is also provided to allow communication between the computer 300 and other computers or computer networks. Network connection 112 allows access to LANs, WANs the Internet or other private and public networks. The interaction between CPU 305, I/O devices 110, bus 115 and memory 310 are well known in the art.

The present invention is directed toward the operation of these elements with respect to data and programs stored in memory 310.

While FIG. 3 illustrates the overall structure of a system used to implement the present invention, further description of the CPU 305 and computer 300 are needed. Given the complexity and resolution needed in present day global coverage numerical weather models, substantial computer processing power is required for near real time weather model generation. The inventors have used a 32 processor IBM p690 “Regatta” system to generate accelerated global coverage weather models in accordance with the present invention.

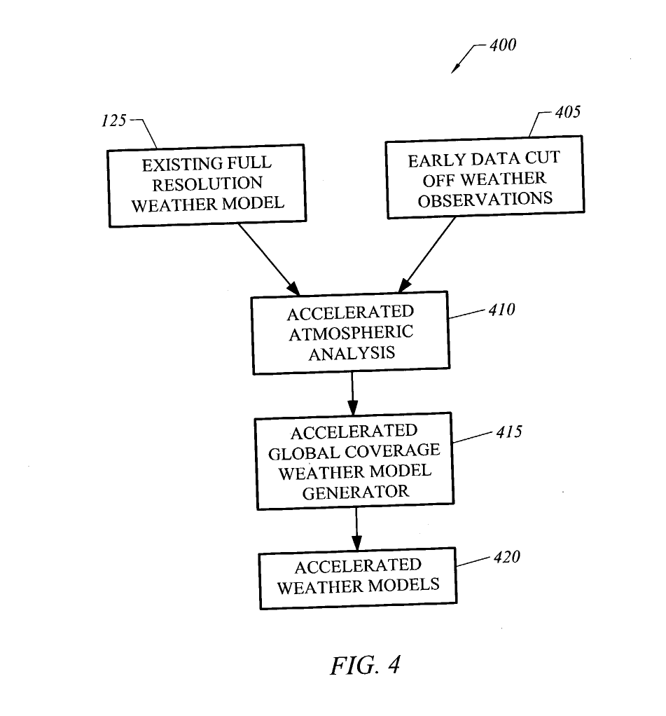

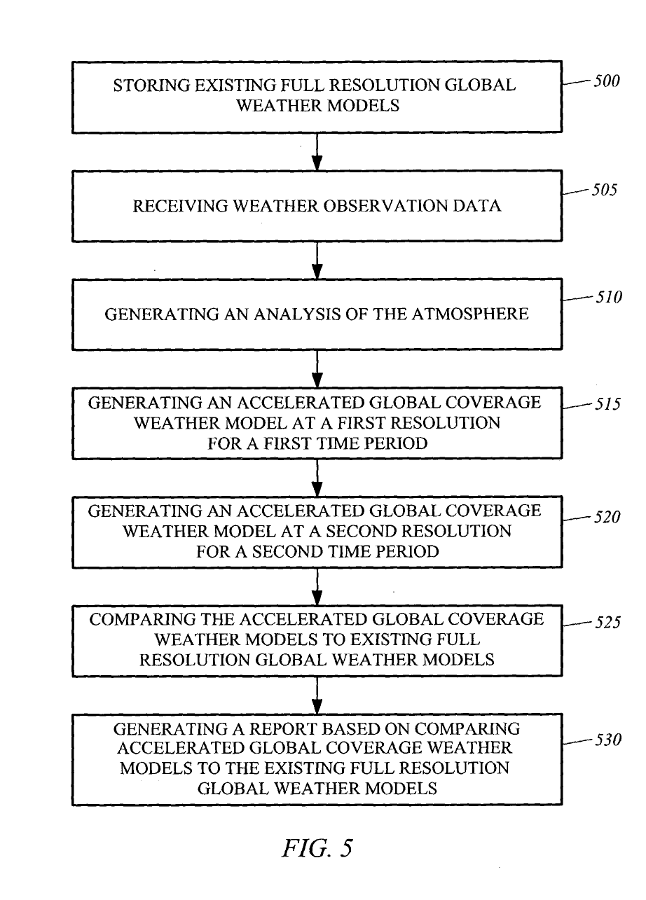

Continuing with FIG. 3, the memory 310 also stores existing full resolution weather model output data 125, early cut off weather observation data 315, an accelerated atmospheric analysis program 320, an accelerated global coverage weather model generator 325, a weather model comparison program 330, a plotting program 335, a report generator 340, accelerated weather model output data 345 and weather model comparison data 350. The overall interaction and use of the programs and data in FIG. 3 are described in FIGS. 4 and 5.

Returning to FIG. 3, plotting program 335 could be any of a variety of suitable computer graphics programs capable of providing a graphical output based on numerical weather model results. A representative plotting program 335 could be, for example, NCAR graphics used in conjunction with the NCAR Command Language. Additionally, the plotting program 335 or memory 310 may include a conversion function to take the numerical model output data (345) from accelerated global model generator 325 and convert it to a format compatible with the plotting program 335. In an example where the plotting program 335 is NCAR Graphics and NCAR command language, the accelerated weather model data 345 can be converted to, for example, WMO GRIB file format. Additional information regarding the WMO GRIB file format is available from NCEP official note 388 at http://www.nco.ncep.noaa.gov/pmb/docs/on388.

Report generator 340 could be any of a variety of computer programs used to produce suitable outputs. For example, report generator 340 could be used to output data such as, for example, formatted text, graphics or a spreadsheet. Report generator 340 may also include specialized report formats to be executed by a specific user or group of users. Such specialized reports and related queries could be created in advance of the generation of the weather model data. By utilizing pre-prepared report queries, the time advantage provided by embodiments of the present invention are maintained. For example, an electricity trader in the northeastern United States may pay close attention to changes in the temperature forecast for the next calendar week. If, during the summer, the weather forecast changes such that a heat wave is more intense than anticipated in eastern Pennsylvania, for example, then that trader may want to buy rights to electricity in eastern Pennsylvania. By utilizing the accelerated weather forecast information provided by embodiments of the invention, the trader would have completed his analysis before the official NCEP weather forecast is released and conducted his trades in advance of rising electricity prices brought on by the hotter weather. Similarly, consider a trader concentrating on natural gas in the Chicago area market who has natural gas rights to sell. Such a trader using accelerated model information of the invention will be aware of a warming temperature trend in advance of the released NCEP weather forecast. This trader may want to sell his natural gas rights before the release of the NCEP weather forecast that indicates the change to warmer temperatures. The NCEP prediction for warmer weather will likely result in weaker natural gas demand and subsequently lower prices.

Attention is now directed to FIG. 4. FIG. 4 illustrates a process flow 400 used to run an accelerated numerical weather model and generate an accelerated numerical weather model output data 420. FIG. 4 illustrates the manner in which the programs and data of FIG. 3 are advantageously employed. The reader is invited to refer to FIGS. 3 and 4 together during the following description.

As described above with regard to full resolution weather models, accelerated weather models also rely on weather observations and existing full resolution weather models. Like the full resolution weather models described above, existing full resolution weather model outputs 125 are also used to generate accelerated weather models of the present invention. However, unlike full resolution weather models, weather observation data (315) for the accelerated weather models of the invention are not collected for the mandated collection period. Instead, weather observation data is collected up to an early data cut off time (405). The early data cut off time is always less than the mandated collection period. In some embodiments of the invention, the early data cut off for weather observations is less than one hour. In a preferred embodiment, the early data cut off for weather observations is about 45 minutes. The weather observation data 315 are similar to the weather observation data 130 in that both are collected by various national meteorological centers around the world and transmitted via global telecommunication networks to NCEP. The observation data is converted to format that can be used to conduct the atmospheric analysis 410 using program 320 (e.g., WMO BUFR). The key distinction between early data cut off weather observations 405 and the weather observation data collected during the mandated period 130 is the amount of time allowed for observation data to be gathered.

Another consequence of the early data cut-off time of the present invention is a reduction in the number of observations received up to the early data cut-off time. The full resolution global coverage model and the accelerated global coverage weather model use the same nominal observation time. Since the accelerated global coverage weather model uses a short data cut off, it is possible during some forecast cycles that a number of observations are received early in the valid observation time period before the nominal observation time. As a result, more observations may be received before the nominal observation time than after the nominal observation time. In some embodiments of the present invention, a number of the global weather observations received before the nominal observation time are disregarded. In this context, disregarded means that the particular weather observation data is not used in the generation of the corresponding accelerated global coverage weather model. In another embodiment, some of the global weather observations received outside of an accelerated valid observation time period are disregarded. One example of an accelerated valid observation time period is a time duration about the nominal observation time plus or minus the early data cut off time period. In an example where the early data cut off time period is 45 minutes and the nominal observation time is 1200 GMT, then the accelerated valid observation time period would be plus or minus 45 minutes about 1200 GMT or accepting global weather observation data valid from 1115 GMT to 1245 GMT. In other words, observational data received outside the accelerated valid observation time period are disregarded.

The invention uses an accelerated atmospheric analysis program 325 to perform an accelerated analysis of the atmosphere 410. The accelerated atmospheric analysis program 320 performs a functions similar to the NCEP GDAS 135 and full resolution atmospheric analysis 210. One input common to both programs is the existing full resolution weather model output 125. Any of the number of earlier generated full resolution weather models may be used as the background for the accelerated weather model. Consider an accelerated global coverage weather model generated for a nominal observation time of 1200 GMT. One earlier generated full resolution weather model could be the 6 hour forecast from the preceding forecast cycle. In this example, the preceding forecast cycle is the NCEP GFS forecast at the nominal observation time of 0600 GMT. The 6 hour forecast from the 0600 GMT forecast cycle would be valid for 1200 GMT and is an acceptable earlier generated full resolution global coverage weather model. Alternatively, the final NCEP GFS model (FNL) from the 0600 forecast cycle may also be used. The FNL GFS model differs from the NCEP GFS model, primarily in data cut off time. The FNL GFS model operates on a data cut off that is often after or later in the forecast cycle than the data cut off for the NCEP GFS model. For example, consider the 1200 GMT forecast cycle (i.e., nominal observation time is 1200 GMT), the GFS model run may use a data cut off of about 2 hours and 45 minutes. During the same forecast period, the FNL model may use a data cut off of about 6 hours. In general, the FNL model forecast is available about six hours and 45 minutes after the nominal observation time. As such, the FNL forecast is also an acceptable background global coverage weather model for an accelerated global coverage model of the present invention.

Unlike the NCEP GDAS 135, the accelerated atmospheric analysis program of the invention differs from NCEP GDAS 135 in at least that it operates at a spectral and grid resolution setting below that used in the NCEP GDAS 135. For example, during a particular forecast cycle, the NCEP GDAS 135 may operate at a resolution level of T254 while the atmospheric analysis program of the invention may operate at a resolution level of T170. Because the accelerated atmospheric analysis program 320 operates at a reduced model resolution, less processing time is needed to perform a given atmospheric analysis. In addition, the accelerated atmospheric analysis 410 has less observation data (315) to compile and process because the accelerated models of the invention employ an early data cut off. Time saved during the accelerated atmospheric analysis 410 is part of the overall time saving advantage of the invention.

Global data assimilation as part of the accelerated atmospheric analysis 410 is performed, similar to the NCEP GDAS 135, using a multi-variate Spectral Statistical Interpolation (SSI) analysis scheme using a 3-dimensional variational technique in which a linear balance constraint is incorporated. Like the NCEP GDAS, the analyzed variables are the associated Legendre spectral coefficients of temperature, vorticity, divergence, water vapor mixing ratio and the natural logarithm of surface pressure. While embodiments of the invention may be performed according to any timeline, the invention may be advantageously operated when the accelerated weather models of the invention are generated to coincide with the full resolution weather models generated by NCEP according to the NCEP forecast day. During a given forecast day, global weather observations are taken, in most cases, every 6 hours to correspond to the 4 daily weather forecasts. The NCEP weather forecasts and corresponding GFS model runs are conducted at 0000, 0600, 1200 and 1800 (all times Greenwich Mean Time (GMT) or Universal Coordinated Time (UTC)). Currently, the mandated collection period for each of the daily NCEP GDAS operations are 0245, 0845, 1445 and 2045 respectively. This means that the NCEP GDAS will gather observational data for 2 hours and 45 minutes before performing the analysis used to initiate the corresponding NCEP GFS run. Accelerated weather modeling processes of the invention may also be performed to correspond to the NCEP forecast period modified as described herein.

After performing the accelerated atmospheric analysis, accelerated global coverage weather models are generated (415). The accelerated global coverage model generator 325 is a computer program representing a global coverage numerical weather model. The accelerated global coverage model generator 325 is similar to the NCEP Global Forecast Model (GFS) 140 described above. The accelerated global coverage model generator 325 also uses the spectral method for its dynamic calculations. In one embodiment, the forecast variables virtual temperature (Tᵥ), vorticity and divergence, surface pressure (p_{sfc}), specific humidity (q), and ozone are calculated using a triangular truncation at waves at a variety of resolutions. The accelerated global coverage model generator 325 and the NCEP GFS 140 differ in at least that during a given forecast period the accelerated global coverage model generator 325 operates at a spectral resolution and grid spacing that is less detailed than the spectral resolution and grid spacing employed by NCEP GFS 140. In one embodiment of the invention, the accelerated global coverage model generator 325 may be operating during a forecast period at a resolution and grid spacing of T170L42 while, during the same forecast period, the NCEP GDAS operates at a resolution and grid spacing of T254L64.

Detail as used herein with regard to a numerical weather model, refers to the size of an atmospheric variation that can be represented in the model. As weather model detail increases, the size of an atmospheric variation that can be represented by the model decreases. A more detailed model is therefore able to represent smaller scale features in the atmosphere. Detail is also related to the granularity of the grid spacing or spectral frequency size present in a model. For a spectral type weather model, detail relates to the ability of a weather model to represent higher frequency weather features in the atmosphere. A spectral type numerical weather model's ability to represent small wave features in the atmosphere is one limit to the detail or size of wave features that can be represented in the model. Increasing detail in a spectral weather model enhances a spectral weather model's ability to capture and accurately represent higher frequency weather features or smaller waves in the atmosphere. For example, a spectral weather model having a spectral resolution of T254 is a more detailed weather model than a spectral weather model having a spectral resolution of T170. For a finite difference type weather model, detail is related to grid spacing. A finite difference type numerical weather model with a smaller, or a finer grid spacing is able to represent smaller scale atmospheric variations. For example, a finite difference type weather model using a 20 km grid spacing is more detailed than a finite difference model using a grid spacing of 40 km. Vertical detail is another apsect of weather model detail for spectral type and finite element type weather models. Vertical detail relates to the number of vertical layers used in a particular weather model. A numerical weather model with more vertical layers is more vertically detailed than a numerical weather model having fewer vertical layers.

Currently, “high resolution” models have a computational array that is truncated at 254 waves or T254. The number of vertical layers represented in the model has also increased. In 2001, 42 sigma levels for vertical resolution was considered “high resolution.” Currently, “high resolution” includes vertical resolution for 64 sigma levels. Resolution as used herein, refers to horizontal (T) and/or vertical (L) components of the model. The resolution of a given model is normally expressed as a truncation level (T) and a sigma level (L). For example, the highest resolution models generated today are T254L64 which means a horizontal truncation of 254 waves with 64 sigma levels of vertical resolution. Current “medium resolution” models are T170L42 and “low resolution” models are T126L28. The relative degrees of resolution of a given numerical weather model have changed in the past as described above and are expected to change in the future. Embodiments of the present invention are described herein in terms of present resolution standards. As will be seen in the discussion that follows, the present invention is equally applicable to numerical weather models at future resolution levels.

Like the NCEP GFS 140, the accelerated global coverage numerical weather model generator 325 has the associated Legendre coefficients of natural logarithm of surface pressure, temperature, vorticity, divergence, water vapor mixing ratio and cloud water/ice as its prognostic variables. The vertical domain includes the surface to 2 mb and is discretized with numerous sigma layers. The Legendre series for all variables are truncated (triangular) at several levels as described above.

Turning now to FIG. 5, processing of the present invention, as executed by the apparatus of FIG. 3, is shown. The processing illustrated in FIG. 5 generally follows the flow path of model generation 400 described above with respect to FIG. 4. The differences between the processes used to generate the prior art full resolution weather models and accelerated weather models of the present invention will be described more fully in the discussion that follows.

First, an existing full resolution global coverage weather model output is stored (500). This block refers to the acquisition of a background grid model (e.g., existing full resolution weather model output data 125) for use by the accelerated atmospheric analysis program 320 of the invention. In most cases, the existing full resolution weather model output data 125 is the 6 hour forecast from the earlier NCEP model run. For example, when preparing for the 1200 GMT model run, the existing full resolution weather model data output 125 or background grid would be the 6 hour forecast from the 0600 GMT NCEP GFS model run available from the NCEP FTP intemet site.

Next, live weather observation data is received (505). Numerous sources of observational data are available. The inventors currently use data from the NOAA Forecast System Laboratory (FSL) Meteorological Assimilation Data Ingest System (MADIS) (http://www-sdd.fsl.noaa.gov/MADIS) and from NOAAPort (http:H/205.156.54.206/noaaport/html/noaaport.shtml). FSL MADIS provides surface observation data (METAR) and non-satellite vertical soundings (RAOB—Rawinsonde/Radiosonde). NOAAPort and the National Weather Service provide satellite observation data

One aspect of the present invention is the use of data cut off time to shorten time to model generation and forecast comparison. Unlike the NCEP global numerical models described above, the accelerated global numerical weather model of the present invention utilizes a data cut off of less than the 2 hour and 45 minutes used by the NCEP model. Alternatively, the accelerated global coverage numerical weather models of the present invention employ data cut off times of less than about one hour, and preferably a data cut off time of about 45 minutes.

Alternatively, receiving weather observation data (505) could be considered as using less live weather observation data for a given model run. If the 2 hour 45 minute data cut off used by NCEP represents a data cut off to allow the highest percentage of weather observation to be collected (e.g., a larger amount of weather observation data 130) and reported, then consider that the percentage of reporting weather observation must be very high, at above 90-95% of available reported observations. The extended data cut off time used by NCEP reflects the reality that many remote global weather observations may require (1) additional time to make the weather observation and (2) successfully transmit that observation to NCEP. One key advantage of the GFS FNL forecast is the long data cut off that allows for more observations taken during the forecast cycle. In the present invention, inclusion of all or most observation data is sacrificed to obtain an earlier start time for the accelerated atmospheric analysis program 320. An earlier start time for the accelerated atmospheric analysis program 320 results in an earlier start time for the accelerated global coverage model generator 325. As such, embodiments of the accelerated global coverage weather models of the present invention rely on less weather observation data than the full resolution global coverage weather models run by NCEP. Alternatively, embodiments of the accelerated global coverage numerical weather model of the present invention may be generated utilizing less than 90% of the available weather observation data for a given forecast start time, or nominal observation time, such as 0000, 0600, 1200 and 1800 GMT.

Next, an analysis of the atmosphere is generated (510). The atmospheric analysis is conducted as described above for FIG. 4 (block 410) and FIG. 3 (block 320). One advantage of the invention is an earlier atmospheric analysis initiation because of the use of earlier data cut off as discussed above. During this step, the received weather observation data in the memory is compiled with the existing full resolution global coverage weather model to represent conditions in the atmosphere.

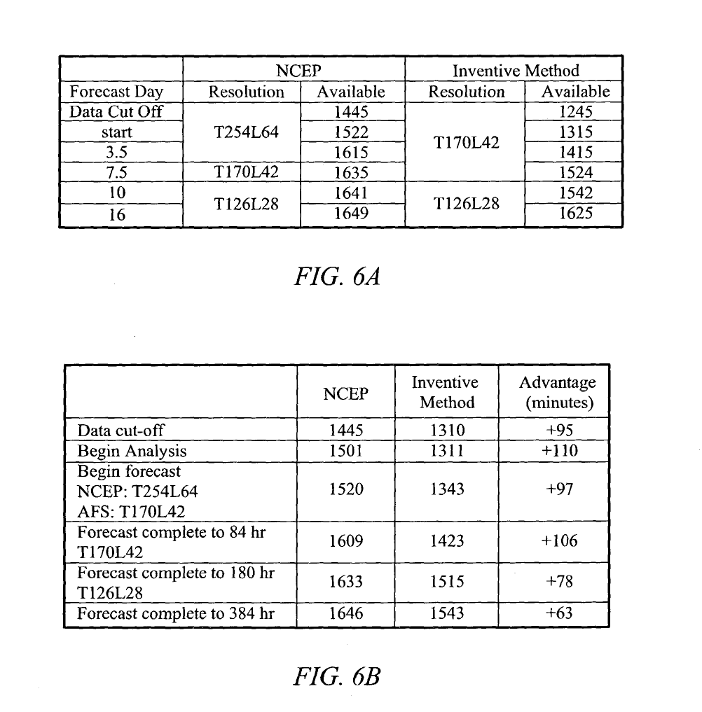

Another advantage of the invention is that either or both the accelerated atmospheric analysis program and the accelerated global coverage weather model generator of the invention are operated at computational array resolution levels at or below the computational array resolution level used by full resolution atmospheric analysis programs and full resolution model generation programs. In one embodiment of the present invention, during the forecast period model run, the accelerated atmospheric analysis program 320 and accelerated global coverage weather model generator 325 are operated initially at a resolution of T170L42 and thereafter at a resolution of T126L28. In an embodiment of the present invention utilized to generate an accelerated 16 day global coverage weather forecast, the first or initial resolution is T170L42 and the second or final resolution is T126L28. In comparison, during comparable portions of the forecast period, the NCEP GFS model would operate at resolution levels of T254L64, T170L42 and T126L28. It is to be appreciated that embodiments of the invention may be advantageously operated using data cut off periods that are less than the data cut off periods used by the full resolution models and that this shortened data cut off period may be used alone or in conjunction with the computational array resolution levels at or less than the computational array resolution levels used by full resolution weather models. Additional model resolution comparison is further described below with regard to FIG. 6.

In an alternative embodiment of the accelerated weather models of the present invention, the model resolution of the background model data is reduced for generating the accelerated global coverage weather model (i.e., 515 and 520) or compiling the received weather observation data to generate an analysis of the atmosphere (i.e., 510). Consider the generation of an accelerated global weather model for the 1200 GMT forecast cycle (i.e., the nominal observation time is 1200 GMT). Both the 0600 GMT NCEP GFS 6 hour forecast valid for 1200 GMT or the 0600 FNL forecast model would be an appropriate existing full resolution global weather model for purposes of the present invention. Currently, the computational array resolution for both of these full resolution models is T254L64. In an alternative embodiment of the present invention, the computational array resolution of the existing full resolution global coverage weather model is reduced prior to performing an accelerated atmospheric analysis. In another embodiment, the computational array resolution of the existing full resolution global coverage weather model is reduced before generating an accelerated global coverage weather model for an extended forecast period. Any of a number of copy computer programs may be used to reduce the resolution of the existing full resolution weather model. For example, one change resolution utility available from NCEP is the so called “GLOBAL_CHGRES” utility. The GLOBAL_CHGRES utility is fully described on the NCEP website at http://www.ncep.noaa.gov and is incorporated by reference herein in its entirety.

Returning now to FIG. 5, accelerated global coverage weather model output data (345) are generated using the accelerated global coverage weather model generator 325. The accelerated global model generator produces accelerated global coverage weather model data 345 corresponding to various model runs during a given forecast cycle. The first accelerated weather model output created by the accelerated global coverage weather model generator 325 is rendered for a first time period at a first resolution (515). The generated model output data 345 are stored in memory 310. The first time period refers to the portion of the forecast period generated at the selected resolution level. In one embodiment, the first time period is 7.5 days of a 16 day forecast at a resolution of T170L42. Other time period and resolution levels are possible and are within the scope of the invention. For example, the forecast period could be divided into more than two time periods. Additionally, more than two model resolutions may be used. For example, the forecast period could be divided into three time periods, an initial, middle and final. A resolution level could be set for each based on current model resolutions used by NCEP or other national weather services. The first time period could have a resolution level higher than the resolution level of the middle time period. The middle time period could have a resolution level above the resolution level above the resolution level of the final time period.

Next, accelerated global coverage weather model output data at a second resolution is generated for a second time period (520). The accelerated weather model output data 345 are stored in memory 310. As described above, the second time period refers to a portion of the total forecast period. The first time period and the second time period add up to the total forecast period. Continuing with the example above, where the first time period is 7.5 days and the forecast period is 16 days, the second time period is 8.5 days. The second resolution refers to the model resolution used by the accelerated global coverage model generator 325 during the second time period. In some embodiments, the second resolution is less than the first resolution. In an alternative embodiment, the second resolution is the same as the resolution used during the NCEP GFS model for the corresponding forecast time period. In a specific embodiment, the first resolution during the first time period is T170L42 and the second resolution of the second time period is T126L28. At the conclusion of block 520, accelerated global coverage weather model output data has been generated and stored in memory (345). In some embodiments, the accelerated global coverage weather model output data are generated for an extended forecast period. The extended forecast period may be more than 6 days. In some embodiments, the extended forecast period is about 9 days. In preferred embodiments, the extended forecast period is a 16 day forecast period.

Next at block 525, the accelerated global coverage numerical weather model output data 345 are compared to the existing full resolution weather model output data 125. In some cases, the earlier existing weather model output data 125 is the 6 hour NCEP generated forecast. Weather model comparison program 330 is a computer based program used to compare the existing full resolution weather model output data 125 and the accelerated weather model output data 324. The comparison program 330 may use a variety of mathematical and statistical algorithms to compare the data from an existing full resolution weather model to the data from an accelerated weather model to identify, for example, portions of the model most likely to change. For example, a comparison of the accelerated weather model generated for a certain forecast period to the existing full resolution model corresponding to that same forecast period can provide indications of changes likely to be reported in the next NCEP forecast cycle. Put another way, by operating an accelerated global coverage weather model according to the invention during an earlier time period, at lower resolution, and with less live observational data, the inventors have found that they may predict the results the NCEP GFS model will produce when it is run later, at higher resolution and with more live observational data.

In one specific comparison operation according to an embodiment of the invention, the comparison function looks at the relative difference between one or more measured meteorological variables generated by the accelerated model to the same one or more meteorological variables generated by the full resolution model. Examples of meteorological variables include, but are not limited to, 500 mb heights, 850 mb temperatures, 1000 mb heights, 250 mb wind, 300 mb wind, 500 mb vorticity, 700 mb relative humidity, mean sea level pressures and total precipitation at hourly intervals of 6, 12, 24, 36, 48 and 60 hours.

Next in block 530, report generator 340 generates reports based on the results created by operating the weather model comparison program 330. Reports created by report generator 340 include any of a wide variety of computer generated reports, including, but not limited to, color coded maps identifying regions of likely change, spreadsheets detailing model outputs and comparison information, graphics indicating model comparison data and computer implemented statistical routines designed to provide an assessment of the probability of change.

Embodiments of the present invention have been described above with regard to spectral resolution numerical weather models. It is to be appreciated that the present invention is also applicable to finite difference models or so called grid point weather models, and to other numerical weather models as well. Reduced resolution for the computational array in finite difference models refers to increased grid point spacing. For example, a full resolution finite difference weather model may have a standard grid spacing of about 10 km. A reduced resolution finite difference weather model may have, for example, a resolution of about 20 km. With regard to vertical layer resolution, the number of vertical layers in a finite difference weather model can be reduced as described above with regard to spectral weather models. Accordingly, embodiments of the present invention may similarly be applied to a wide variety of numerical weather models.

Accelerated global coverage weather models according to embodiments of the present invention differ from full resolution weather models in a number of ways. For example, accelerated weather models of the invention may use computational array resolution that is lower than the computational array resolution used in the full resolution model. Lower here refers to fewer waves or lower wave number for a spectral weather model type or wider grid spacing for a finite difference weather model type. Vertical component resolution of the computational array refers to the number of vertical layers used. Lower vertical component resolution indicates fewer vertical layers. In addition, accelerated weather models use a shorter data cut off time than in full resolution models. In some embodiments of the accelerated models of the present invention, some valid weather observation data may be disregarded as a result of the use of the shorter data cut off time. Because of the time delay in collecting and reporting some types of observation data, those types of observation data delayed long enough to be received after the short data cut off of the accelerated weather models of the invention will also be disregarded. Thus, accelerated weather models of embodiments of the present invention may differ, in varying combinations and degree, from full resolution models in data cut off time, the number of weather observations used, and the computational array resolution, including both horizontal and vertical components.

We turn our attention now to FIGS. 6A and 6B. FIGS. 6A and 6B compare the model generation capabilities of the full resolution weather models generated by NCEP and the accelerated model generation capabilities of embodiments of the present invention. The examples consider the daily time line for generation of a 1200 GMT forecast. This refers to “start” in the “Forecast Day” column of FIG. 6A. The models in the examples below follow the process flow 200 (FIG. 2) in the case of NCEP and process flow 400 (FIG. 4) in the case of the invention. Both the NCEP and invention models obtain a suitable earlier generated or existing full resolution global coverage weather model for the background. Either the GFS FNL forecast or the 6 hour forecast from the 0600 GMT NCEP forecast would be acceptable background models. The 6 hour forecast, for example, provides the existing full resolution weather model output data 125 for both models as well as a starting point for the upcoming analysis.

The following discussion refers to the comparative example in FIG. 6A. Next, assemble the 1200 GMT observational data or weather observations. In the case of the NCEP model, data cut off for observation data is for a mandated data collection period. In this example, the mandated data collection period is 2 hours and 45 minutes or at 1445 GMT. (See FIG. 6A under NCEP column). On the other hand, the invention preferably uses an early data cut off of less than the NCEP model. More preferably, the early data cut off is usually less than 1 hour. In a preferred embodiment described herein, the early data cut off is 45 minutes at 1245Z (refer to FIG. 6A, Data Cut Off line under Inventive Model column).

Next, with observational data and a background model, the inventive method conducts an atmospheric analysis using the accelerated atmospheric analysis program 320. The accelerated atmospheric analysis program 320 in this embodiment of the invention is performed at a resolution of T170L42 and is completed by 1315 GMT. This corresponds to the model start time reflected in FIG. 6A “start” row under the “Inventive Method” column. Notice that at this time (1315 or the start time for the accelerated model generator), the NCEP model is still collecting observation data. (See FIG. 6A, NCEP Data Cut Off will not occur until time 1445) After the accelerated atmospheric analysis is completed, the accelerated global coverage weather model generator 325 begins to generate accelerated global coverage numerical weather model output data 345. (See FIG. 6A “start” under “Inventive Method” is 1315). As indicated in FIG. 6A, the accelerated global coverage weather model generator in this embodiment of the invention operates at a resolution of T170L42 out to 7.5 days. As can be seen, the accelerated weather model 3.5 day forecast is available at 1415 and the accelerated weather model 7.5 day forecast is available at 1524. Next, with reference to the “resolution” column under “Inventive Method” in FIG. 6A, the resolution of the accelerated global coverage weather model generator is truncated to a resolution of T126L28 and accelerated global coverage weather model generation resumes. With reference to “Available” column under “Inventive Method” in FIG. 6A, the accelerated weather model 10 day forecast is available at 1542 and the accelerated weather model 16 day forecast is available at 1625.

The NCEP model has an observation data cut off at 1445 GMT (or 2 hours and 45 minutes after forecast start, See FIG. 6A). The NCEP GDAS performs an analysis of the atmosphere based on the same 6 hour forecast describe above with regard to the invention, but bases it on the observational data collected during the 2 hour and 45 minute data collection period. The NCEP GDAS analysis is completed by about 1522 (see FIG. 6A “start” row under “NCEP” column). The NCEP GFS begins generating forecast models at T245L64 resolution as shown in FIG. 6A “start” row under “NCEP” column. The 3.5 day full resolution forecast is available by 1615 GMT (See FIG. 6A “3.5” row under the “NCEP” column). With reference to FIG. 6A under Forecast Day 7.5, the NCEP GFS truncates resolution at T170L42. The full resolution 7.5 day forecast is available at 1635 GMT (refer to FIG. 6A, 7.5 under “forecast day” and “available” under “NCEP” column). The NCEP GFS again truncates GFS resolution, this time to T126L28 for the remainder of the forecast period. As shown in FIG. 6A, the full resolution 10 day forecast is available at 1641 GMT and the full resolution 16 day forecast is available at 1649 GMT.

FIG. 6A illustrates the time saving benefit of the accelerated weather models of the present invention. The invention produces an accelerated global coverage, 16 day forecast before the full resolution NCEP 16 day weather forecast. The accelerated 16 day forecast provided by the invention is available more than 20 minutes before the full resolution 16 day NCEP forecast is provided. The benefits of the invention are even greater when considering other forecast days within the forecast period. For example, the accelerated 3.5 day forecast of the invention is available a full 2 hours before the full resolution NCEP 3.5 day forecast. The accelerated 7.5 day forecast of the invention is available more than 70 minutes before the full resolution NCEP 7.5 day forecast. The accelerated 10 day forecast of the invention is available more than 55 minutes before the full resolution NCEP 10 day forecast. Finally, the accelerated 16 day forecast of the invention is available more than 25 minutes before the full resolution NCEP 16 day forecast.

As illustrated in FIG. 6A, traders using accelerated forecast results provided by embodiments of the invention have a time advantage over traders who have to wait for the full resolution forecasts generated by NCEP. For example, consider a trader and his position based in part on the outcome of the 3.5 day forecast. If the trader had access to the accelerated 3.5 day forecast data, comparison results and generated reports of the present invention, then he would be evaluating his position at about 1415 GMT. This trader would have a considerable time advantage over a trader who relied on the NCEP full resolution 3.5 day forecast. As illustrated in FIG. 6A, the trader relying on the NCEP full resolution forecast will not have forecast data or the ability to begin his analysis until about 2 hours after the trader who had access to the forecast, comparisons and reports produced by embodiments of the invention.

The following discussion relates to the illustrative comparison in FIG. 6B. Next, assemble the 1200 GMT observational data or weather observations up to the data cut off time. In the case of the NCEP model, data cut off for observation data is for a mandated data collection period. In this example, the mandated data collection period is 2 hours and 45 minutes or at 1445 GMT. (See FIG. 6B under NCEP column). On the other hand, the invention preferably uses an early data cut off of less than the NCEP model. More preferably, the early data cut off is usually less than 90 minutes. In a preferred embodiment described herein, the early data cut off is 70 minutes at 1310Z (refer to FIG. 6B, Data Cut Off line under Inventive Model column).

Next, with observational data and a background model, the inventive method conducts an atmospheric analysis using the accelerated atmospheric analysis program 320 (“Begin Analysis”). The accelerated atmospheric analysis program 320 in this embodiment of the invention is performed at a resolution of T170L42 and started at 1311Z and is completed by 1343 GMT. This corresponds to the “Begin Forecast” time reflected in FIG. 6B under the “Inventive Method” column. Notice that at this time (1311 Z or the start time for the accelerated model generator or accelerated forecasting system or AFS), the NCEP model is still collecting observation data. (See FIG. 6B, NCEP Data Cut Off will not occur until time 1445) After the accelerated atmospheric analysis is completed, the accelerated global coverage weather model generator 325 begins to generate accelerated global coverage numerical weather model output data 345. (See FIG. 6B “Begin Forecast” under “Inventive Method” is 1343). As indicated in FIG. 6B, the accelerated global coverage weather model generator in this embodiment of the invention initially operates at a resolution of T170L42. The accelerated weather model 3.5 day or 84 hour forecast is available at 1423 and the accelerated weather model 7.5 day or 180 hour forecast is available at 1515. Next, the resolution of the accelerated global coverage weather model generator is truncated to a resolution of T126L28 and accelerated global coverage weather model generation resumes. The accelerated weather model 16 day or 384 hour forecast is available at 1543.

The NCEP model has an observation data cut off at 1445 GMT (or 2 hours and 45 minutes after forecast start). The NCEP GDAS performs an analysis of the atmosphere based on the same 6 hour forecast describe above with regard to the invention, but bases it on the observational data collected during the 2 hour and 45 minute data collection period. The NCEP GDAS analysis begins at 1501 and is completed by about 1520. The NCEP GFS begins generating forecast models at T245L64 resolution as shown in FIG. 6B “Begin Forecast” row under “NCEP” column. The 3.5 day or 84 hour full resolution forecast is available by 1609 GMT. With reference to FIG. 6B at Forecast Day 7.5 or 180 hour, the NCEP GFS truncates resolution at T170L42. The full resolution 7.5 day or 180 hour forecast is available at 1633 GMT. The NCEP GFS again truncates GFS resolution, this time to T126L28 for the remainder of the forecast period. As shown in FIG. 6B, the full resolution 16 day or 384 hour forecast is available at 1646 GMT.

A review of FIG. 6B illustrates the time saving benefit of the accelerated weather models of the present invention. Embodiments of the present invention produce accelerated global coverage weather model forecasts in advance of the full resolution NCEP weather model forecasts. The time advantage benefits provided by the invention are considerable for all forecast days within the forecast period. For example, the accelerated 3.5 day or 84 hour forecast of the invention is available 106 minutes before the full resolution NCEP 3.5 day forecast. The accelerated 7.5 day or 84 hour forecast of the invention is available more than 78 minutes before the full resolution NCEP 7.5 day forecast. The accelerated 16 day or 384 hour forecast of the invention is available 63 minutes before the full resolution NCEP 16 day forecast.

As illustrated in FIG. 6B, traders using accelerated forecast results provided by embodiments of the invention have a time advantage over traders who must wait for the full resolution forecasts generated by NCEP. For example, consider a trader and his position based in part on the outcome of the 3.5 day forecast. If the trader had access to the accelerated 3.5 day forecast data, comparison results and generated reports of the present invention, then he would be evaluating his position at about 1423 GMT. This trader would have a considerable time advantage over a trader who relied on the NCEP full resolution 3.5 day forecast. As illustrated in FIG. 6B, the trader relying on the NCEP full resolution forecast will not have forecast data or the ability to begin his analysis until about 40 minutes after the trader who had access to the forecast, comparisons and reports produced by embodiments of the invention.

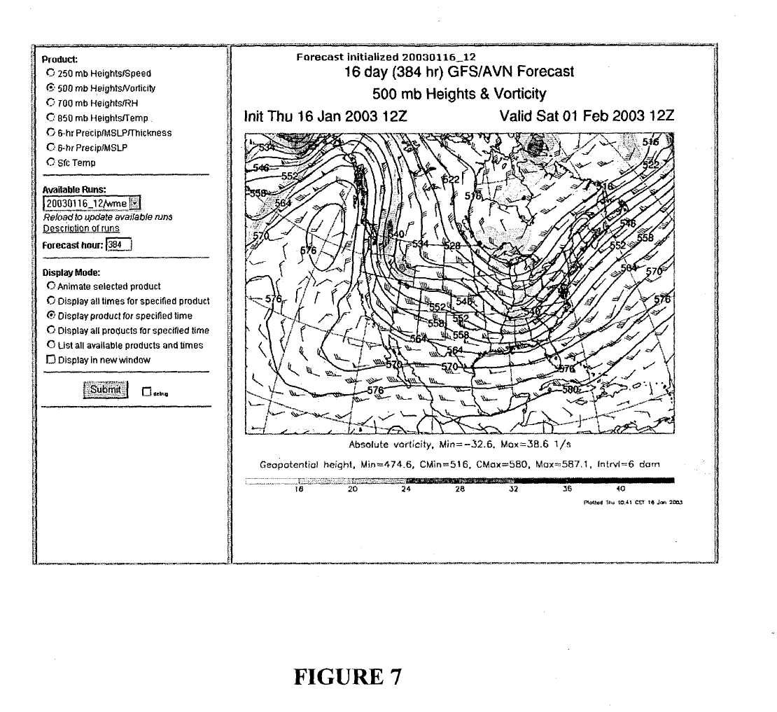

Turning now to FIG. 7. FIG. 7 represents an embodiment of a graphical user interface to access weather model, comparison results and reports according to the inventive method. The user interface may be used via appropriate network connections to allow users to access the accelerated global coverage weather models of the present invention. Appropriate computer readable medium, such as C++, HTML or other GUI computer programs may be used to create executable instructions to allow a user to navigate through the various options illustrated in the output of FIG. 7. A user may select the desired product, available forecast run, as well as desired display mode. These outputs are only illustrative and other user selected weather variables are possible.

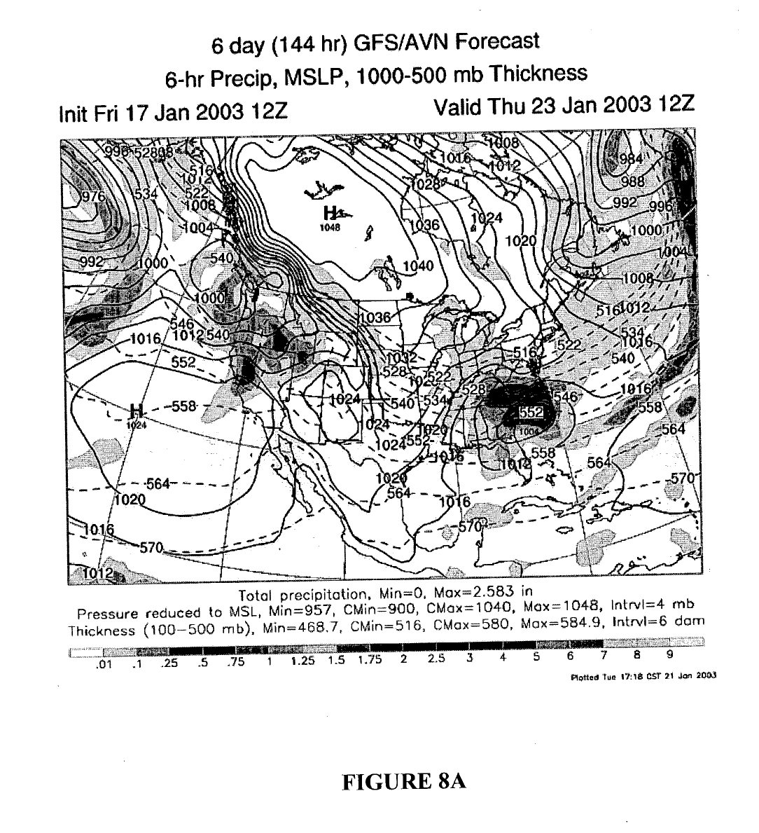

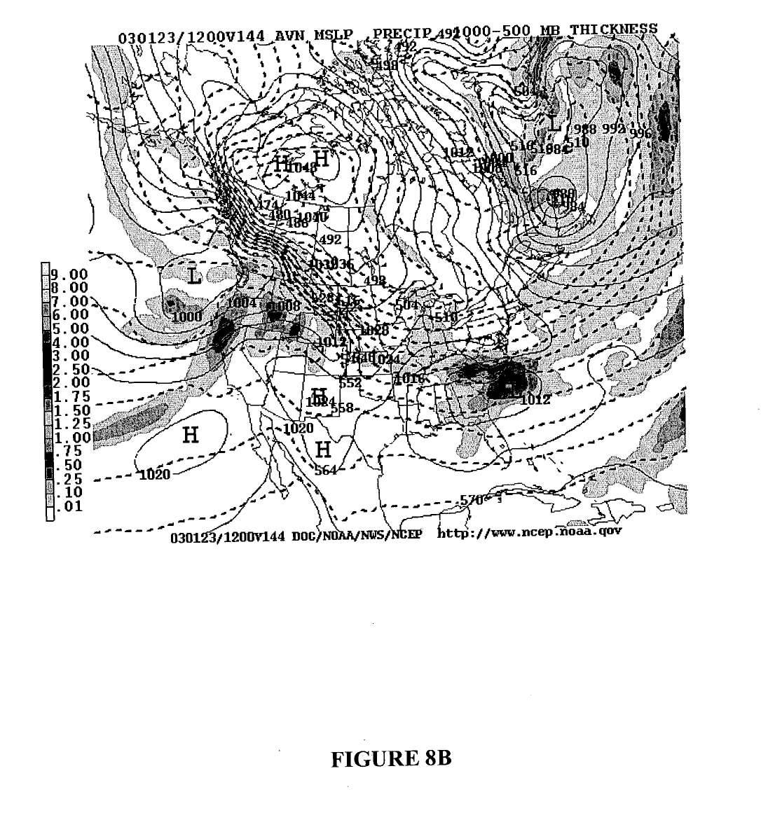

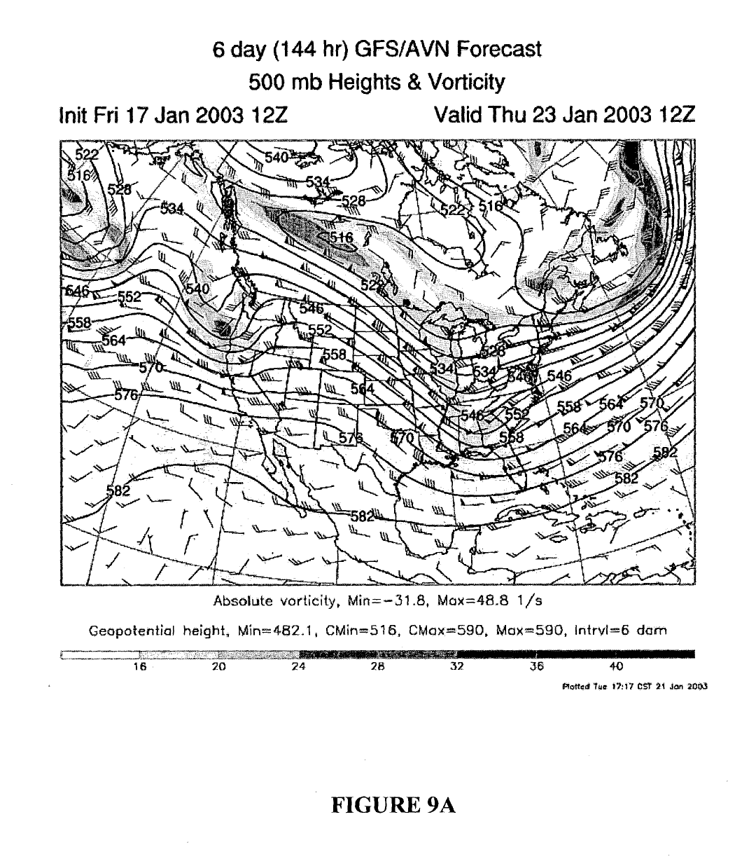

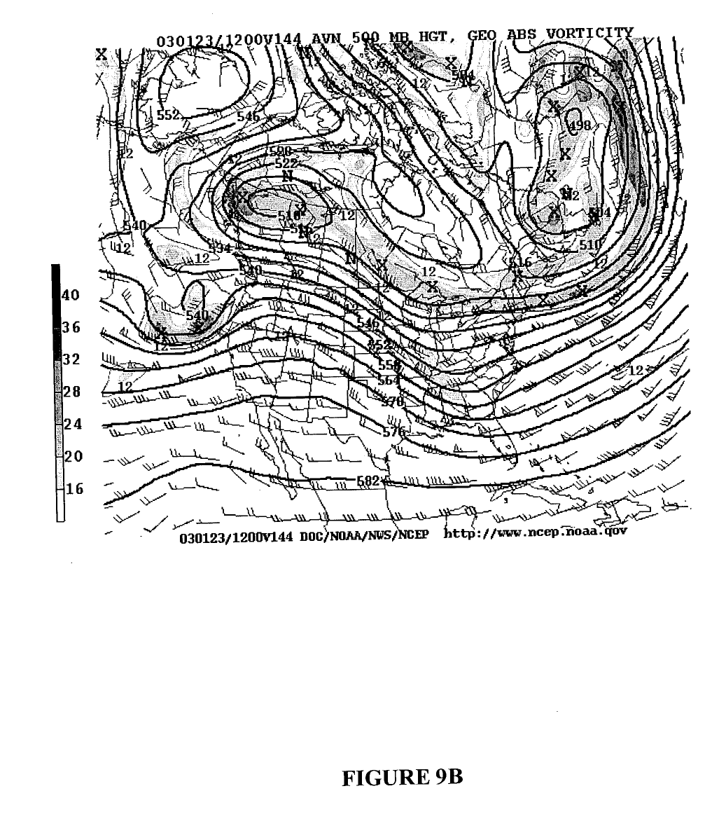

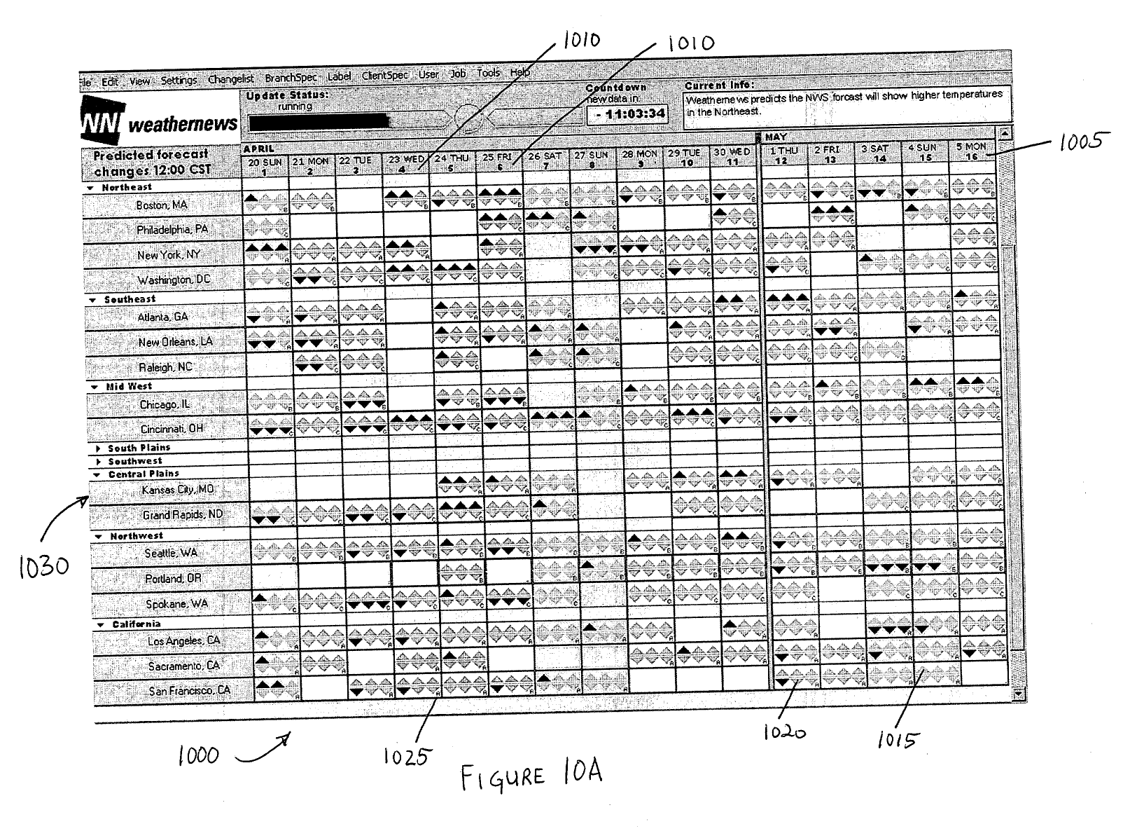

FIGS. 8A-9B illustrate generated graphical outputs from an existing full resolution global coverage weather model (FIGS. 8B and 9B) and the corresponding forecasted variable from an accelerated global coverage weather model of the present invention (FIGS. 8A and 9A). FIGS. 8A and 8B provide 500 mb heights and vorticity forecast outputs for the NCEP model (FIG. 8B) and the inventive model (FIG. 8A). FIGS. 9A and 9B provide 6 hour precipitation, MSLP and 1000-500 mb thickness outputs for the NCEP model (FIG. 9B) and the inventive model (FIG. 9A).

These figures are illustrative of the generated graphical outputs that may be used to compare the full resolution global coverage weather model to the accelerated global coverage weather model. Other outputs are possible and include, for example, different geographic areas of interest, different forecast variables, or different forecast time periods. The generated graphical outputs for FIGS. 8A through 9B illustrate North America and a portion of Central America. It is to be appreciated that the generated graphical output could be any geographic region of the world. FIGS. 8A through 9B illustrate only a few of the available forecast variables. In addition to the displayed forecast variables, the generated graphical output may include an output of a forecasted weather variable such as, for example, temperature, atmospheric thickness, humidity, heat index, geopotential height, wind speed, pressure and precipitation.

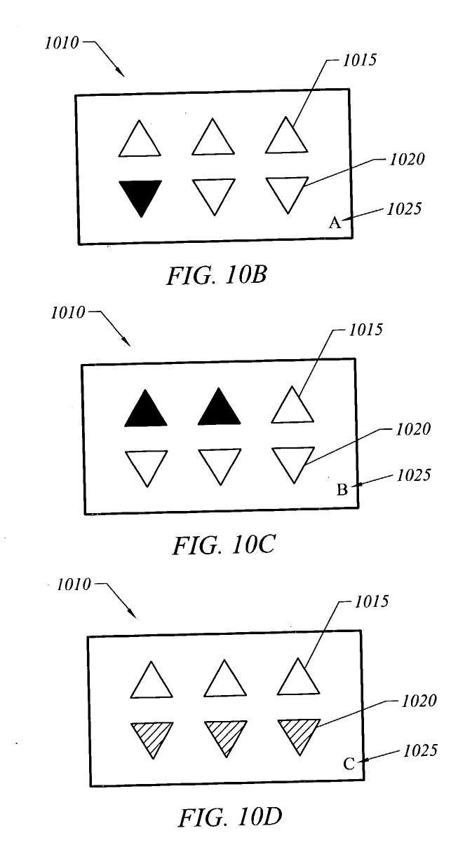

FIGS. 10A through 10D are illustrative embodiments of a report representing the likely changes in a full resolution global coverage weather model. The report 1000 may be generated using a computer readable medium that contains executable instructions to generate a displayed geographic location 1030 and executable instructions to generate a forecast duration 1005 having a plurality of subdivided time periods 1010. Additionally, for a specific geographic location during each of the subdivided time periods 1010 there is provided at least one of a computer generated visual indication of an increase in a forecast variable 1015, a computer generated visual indication of a decrease in a forecast variable 1020, a computer generated visual indication of the magnitude of an increase in a forecast variable, and a computer generated visual indication of the magnitude of a decrease in a forecast variable. In addition, for each of the subdivided time periods 1010 there is provided an indicator 1025 signifying the confidence level in the computer generated visual indication of forecast variable change and magnitude.

FIG. 10A illustrates a report 1000 representing the likely changes in a full resolution global coverage weather model for the forecast variable of temperature. Executable code (e.g., report generator 340; FIG. 3) stored on a computer readable medium (e.g., memory 310; FIG. 3) may be used to generate user requested reports of any duration up to the full forecast duration. Report 1000 illustrates a 16 day forecast period of a preferred embodiment of the present invention. The report generator 340 may be modified to produce reports of any desired duration ranging, for example, from 3 days, to less than 16 days to 16 days. Additionally, the report 1000 illustrates an embodiment where the plurality of subdivided time periods are one day. The subdivided time intervals are labeled 1 through 16 corresponding to the forecast day. The forecast duration represents a calendar report ranging from Sunday, April 20 through Monday, June 5. While the forecast variable of temperature is illustrated, the computer readable medium may be modified to generate a report on any selected forecasted weather variable, such as for example, humidity, heat index, atmospheric thickness, wind speed, geopotential height, pressure, and precipitation.

The symbols and format used in report 1000 will be better appreciated through the following examples. FIG. 10B illustrates a representative subdivided time period 1010 for Friday, April 25 for New Orleans, La. In this representative subdivided time period 1010, a single computer generated visual indication of a decrease in a forecast variable 1020 is shown. The confidence level for this visual indication is level A 1025 or a high degree of confidence. Other locations and time periods, with a single computer generated visual indication of change in a forecast variable 1020 include, for example, Boston, Mass. on Monday, April 28; Philadelphia, Pa., on Sunday, April 27; Atlanta, Ga. on Monday, May 5; New Orleans, La. on Sunday, May 4; Chicago, Ill. on Friday, May 2; Kansas City, Mo. on Thursday, May 1; and Sacramento, Calif., on Monday, May 5.

FIG. 10C illustrates a representative subdivided time period 1010 for Wednesday, April 23 for Boston, Mass. In this representative subdivided time period 1010, two computer generated visual indications of an increase in the forecast variable 1020 are shown. The confidence level for this visual indication is level B 1025 or a medium degree of confidence. Other locations and time periods with two computer generated visual indications of a change in a forecast variable 1020 include, for example, Boston, Mass. on Saturday, May 3; Philadelphia, Pa. on Saturday, April 26; New York, N.Y., on Monday, April 28; New Orleans, La. on Friday, May 2; Raleigh, N.C., on Monday, April 21; Grand Rapids, N. Dak. on Tuesday, April 22; Portland, Oreg., on Sunday, May 4; and San Francisco, Calif., on Sunday, April 20.

FIG. 10D illustrates a representative subdivided time period 1010 for Friday, April 25 for Spokane, Wash. In this representative subdivided time period 1010, three computer generated visual indications of a decrease in the forecast variable 1020 are shown. The confidence level for this visual indication is level C 1025 or a low degree of confidence. Additionally, the visual indications of a decrease in the forecast variable 1020 may also be generated in a different color to further draw attention to the large magnitude change (i.e., where three visual indicators are used). This additional computer generated visual cue (i.e., color) may also be used when a large magnitude change either increasing or deceasing is predicted. In the illustrative embodiment of FIG. 10A, large magnitude changes are also predicted, for example, for Philadelphia, Pa. on Friday, May 2; New York, N.Y. on Sunday, April 20, and Sunday, April 27; Washington, D.C. on Thursday April 24; and Cincinnati Ohio on Sunday, April 20; Tuesday, April 22; Wednesday, April 23; Saturday, April 26; and Tuesday, April 29.

It is to be appreciated that while the geographic regions 1030 illustrated, and described above with regard to FIGS. 10A through 10D are for portions of the United States, other geographic regions may also be used. Accordingly, the computer readable medium may be modified to provide report outputs for any desired geographic region of the world. In much the same way, any of a wide variety of cities or global regions may be selected for display in the report. Additionally, a user may remotely access the computer being used to generate the computer generated visual display of a weather forecast variable and select a desired report of likely changes in a forecast variable. The user selections may include, for example, the weather forecast variable, the geographic location and time period. The user would access through the computer network connection 112 using methods well known in the art, such as for example, using a login ID over a secure network connection, accessing a secured or limited access internet site or entering a pay for access internet portal.

Another advantage provided by embodiments of the present invention is the use of the information and reports generated by the invention to determine a trading position in a financial market. A number of financial markets exist around the world. These financial markets include trading exchanges where both physical and financial instruments are bought and sold. Examples of these trading exchanges include: to New York Mercantile Exchange (NYMEX), the Chicago Mercantile Exchange (CME), the Chicago Board of Trade (CBOT), the Euronext.liffe (EUREX), the Tokyo Grain Exchange, the Tokyo International Financial Futures Exchange, the Tokyo Commodity Exchange, the Singapore Commodity Exchange Limited, and the Winnipeg Commodity Exchange to name a few. In fact, trading exchanges exist in most major cities or regions around the globe. In general, exchanges provide a wide array of trading markets that include physical markets where an actual commodity is physically traded as well as financial instruments including, for example, futures and options contracts for the desired commodity. The commodities provided by the various global trading exchanges are extensive and vary by region and exchange. Some of the most common trading commodities include crude oil, gasoline, heating oil, natural gas, electricity, and agricultural products.

Some trading commodities are impacted by the weather to such a degree that changes in expected or predicted weather patterns result in trading activity. For example, a predicted heating trend during the summer months may cause higher demands for electricity in those regions seeing higher temperatures. However, if the heating trend is either not predicted for a certain geographic region or less than previously predicted for a certain region, then the market for electricity, particularly in those impacted markets, may change dramatically. In markets where the weather is a factor for consideration in trading there exists an index of market consensus for the weather forecast. The index of market consensus for the weather forecast is a weather forecast that is relied upon by the majority of traders for a given commodity, or certain market, or is considered generally to be the accurate weather forecast relied upon for making trading decisions. In many cases the index of market consensus for the weather forecast is a full resolution global coverage weather model. For many commodities markets, especially those in the United States, the index of market consensus for the weather forecast is the NCEP GFS weather forecast. Other regions of the world or other markets may use a different index of market consensus for the weather forecast.

Another embodiment of the present invention provides a method for determining a trading position in a financial market by generating a computer-based accelerated global coverage weather model of a full resolution global coverage weather model. Here, the process of generating a computer-based accelerated global coverage weather model is as described above with regard to FIGS. 3, 4 and 5.

In this embodiment, the full resolution global coverage weather model is advantageously selected to represent the index of market consensus for the weather forecast. Next, the generated accelerated global coverage weather model is used to produce an output representing the likely changes in the full resolution global coverage weather model. The output is produced by comparing the accelerated global coverage weather model to the full resolution global coverage weather model. These results are particularly useful because the comparison is based on the full resolution global coverage weather model representing the index of market consensus for the weather forecast. After reviewing the output representing the likely changes in the full resolution global coverage weather model representing the index of market consensus for the weather forecast, a trader may adjust a trading position of a trading instrument based upon the results represented in the output. In other words, the methods of embodiments of the present invention provide likely predictions of the changes to a global coverage weather model representing the index of market consensus for the weather forecast. Based on these advanced predictions, a trading position may be changed before the weather model representing the index of market consensus for the weather forecast is widely known and the market has adjusted to the changes—expected and unexpected—in the weather forecast.

Additionally, the output representing the likely change in the full resolution global coverage weather model may include likely changes in a forecasted weather variable. The forecasted weather variable may be, for example, temperature, humidity, heat index, atmospheric thickness, wind speed, geopotential height, pressure, and precipitation. A trader may select a forecast variable or combination of weather variables and forecast duration to assist in his trading decision. The desired forecast duration may also be selected based upon the timing of the forecast relative to a trade impacting event. A trade impacting event is any event that influences the market reaction or trading decisions. Examples of trade impacting events include, for example, a government report on crop production like the orange crop or cotton crops or a periodically generated industry report for production of certain goods. One specific example of a trade impacting event is the United States Department of Agriculture (USDA) Weather and Crop Bulletin (http://www.usda.gov/oce/waob/jawf/wwcb.html). The USDA releases this report every Tuesday at noon eastern time. A trader interested in adjusting a trading position based on the likely market response to this government report may advantageously select accelerated global coverage weather models, reports and other outputs of the present invention so that he may anticipate the likely market response to the USDA bulletin. If a trade impacting event occurs on the first day of every calendar month, then a trader may place greater importance on a report generated according to the present invention having a report duration that overlaps and includes the date of the trade impacting event. Other combinations of commodity and forecast duration are possible and vary depending upon commodity traded. A commodity trader interested in natural gas futures, for example, may select temperature as a weather variable of interest with a variety of forecast durations based upon the physical or financial market of interest. A five to 16 day weather forecast might be more beneficial for natural gas futures and options, while physical sales may benefit from shorter term forecast durations such as from one to three days, for example. A trader interested in the electricity markets may pay particular attention to the weather variables of temperature, precipitation, humidity, and wind. A trader interested in weather derivatives may pay particular attention to temperature and precipitation as weather variables during a one to two week forecast duration.

Another advantage of the present invention is the use of the accelerated global coverage weather models, reports and other outputs of the present invention on a time scale that corresponds to trading hours for a financial market of interest or before a scheduled update to the index of market consensus for the weather forecast is generally available. For purposes of discussion assume that the trading hours for global commodities markets are from 9 am to 3 pm local time. Also assume for the following examples that the full resolution global coverage weather model representing the index of market consensus for the weather forecast is the NCEP GFS model produced daily every 6 hours at nominal observation times of 0000, 0600, 1200 and 1800 GMT. As described above with regard to FIG. 6, accelerated forecast results are being generated after about one hour and 15 minutes by embodiments of the present invention and are ready for comparison to full resolution global coverage weather models. Generated accelerated, extended forecast global coverage weather models according to embodiments of the present invention are available after approximately four hours and 25 minutes (FIG. 6). As a result, embodiments of the present invention may be advantageously performed for a specific nominal observation time selected to correspond to the generation of accelerated model output and corresponding comparisons made during the trading hours of a financial market of interest. The following examples illustrate the point. In the case where the financial market of interest is based in the United States, the 1200 GMT nominal observation period is desirable because accelerated global coverage weather models, reports and other outputs of the present invention may be generated during trading hours for financial markets in the United States. Thus, traders interested in adjusting their trading positions in markets in the United States, may pay particular attention to those results based on the 1200 GMT nominal observation time. For the reasons described above, traders interested in adjusting their trading positions in markets in Europe may pay particular attention to the 0600 GMT nominal observation time. When the embodiments of the present invention are used with the 0600 GMT nominal observation time, accelerated global coverage weather models, reports and other outputs of the present invention may be generated and are available for regions in Europe, Africa and the Middle East including cities such as Amsterdam, Paris, Barcelona, Rome, Johannesburg, Stockholm, Berlin, and Vienna. For the reasons described above, traders interested in adjusting their trading positions in markets in the Asian region and time zones may pay particular attention to the 0000 GMT nominal observation time. When the embodiments of the present invention are used with the 0000 GMT nominal observation time, accelerated global coverage weather models, reports and other outputs of the present invention may be generated and are available for regions of the world including the cities, for example, Hong Kong, Bangkok, Beijing, Jakarta, Perth, Rangoon, Sidney, Manila and Tokyo. While the above examples illustrate the availability of accelerated global coverage weather models, reports and other outputs of the present invention during normal trading hours it is to be appreciated that a trader interested in after-hours trading will select a different nominal observation time to meet the timing requirements for that trading environment. Additionally, there may exist times when embodiments of the present invention may provide accelerated global coverage weather models, reports and other outputs before a scheduled update to the index of market consensus for the weather forecast is generally available.

In another example, accelerated global coverage weather models, reports and other outputs of the present invention may be used to generate an output similar to the report 1000 of FIG. 10A. A trader receives the report 1000 that is an output representing the likely changes in the full resolution global coverage weather model. The report generated is of course adjusted to correspond to the particular variables of interest for the trader such as, for example, weather variable, dates and region of interest and so forth. The trader may then determine his trading position in a financial market (buy, sell, hold, etc.) and adjust his holdings in advance of others trading in that financial market that do not use the accelerated global coverage weather models, reports and other outputs created by embodiments of the present invention. In another embodiment, the accelerated weather models, reports and other outputs of embodiments of the invention are generated such that a trader may adjust his trading position during the trading hours of a financial market of interest. In an alternative embodiment, the accelerated weather models, reports and other outputs of embodiments of the invention are generated such that a trader may adjust his trading position during the trading hours of a financial market of interest and before a scheduled update to the index of market consensus for the weather forecast is generally available. For example, during the 1200 GMT, nominal observation time forecast cycle, the accelerated weather models, reports and other outputs of embodiments of the invention are available during the trading day of the US-based markets and in advance of the generally available update to the NCEP GFS model (i.e., the index of market consensus for the weather forecast).

The foregoing descriptions of specific embodiments of the present invention are presented for purposes of illustration and description. They are not intended to be exhaustive or to limit the invention to the precise forms disclosed, obviously many modifications and variations are possible in view of the above teachings. For example, the above embodiments have been described with reference to weather models and organizations of the United States. The teachings of the invention are applicable to weather models used elsewhere in the world. The above description utilized the NCEP GFS model for comparison. It is also to be appreciated that the teachings of the invention may also be applied to other existing weather models, such as, for example, the ECMWF (European Center For Medium Range Weather Forecasting), or the weather models under development, such as for example, the WRF model (Weather Research and Forecasting Model).

It is to be appreciated as well that while the global coverage numerical weather model has been described with regard to the NCEP GFS model in the United States, the teachings of the present invention are not so limited. The advantages of present invention may be used for weather models utilized by other national, or regional weather services or other weather models of interest. In particular, the present invention may be used to advantage with the weather forecast model representing the index of market consensus for the weather forecast of a given market or geographic region or commodity of interest. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

We claim:

1. A numerical weather model generation method executed by a computer under the control of a program, said method comprising the steps of:
a) storing an existing full resolution global coverage weather model in a memory;
b) receiving a plurality of global weather observation data for less than a mandated observation period;
c) compiling the received weather observation data in the memory with the stored existing full resolution global coverage weather model to represent conditions in the atmosphere; and
d) generating an accelerated global coverage weather model for an extended forecast period based in part on the received weather observation data using a resolution value less detailed than a resolution value used to generate the existing full resolution global coverage weather model.

2. A numerical weather model generation method according to claim 1, wherein the existing full resolution global coverage weather model is one of either a spectral weather model or a finite difference weather model.

3. A numerical weather model generation method according to claim 2, wherein the accelerated global coverage weather model is the same type of weather model as the full resolution global coverage weather model.

4. A numerical weather model generation method according to claim 1, wherein the resolution value less detailed than a resolution value used to generate the existing full resolution global coverage weather model is spectral resolution.

5. A numerical weather model generation method according to claim 1, wherein the resolution value less detailed than a resolution value used to generate the existing full resolution global coverage weather model is spectral resolution and vertical resolution.

6. A numerical weather model generation method according to claim 1, wherein the resolution value less detailed than a resolution value used to generate the existing full resolution global coverage weather model is grid point spacing.

7. A numerical weather model generation method according to claim 1, wherein the resolution value less detailed than a resolution value used to generate the existing full resolution global coverage weather model is grid point spacing and vertical resolution.

8. A numerical weather model generation method according to claim 1, wherein the existing full resolution global coverage weather model is based on the National Center Environmental Prediction (NCEP) Global Forecast System (GFS) model.

9. A numerical weather model generation method according to claim 8, wherein the existing full resolution weather model is the 6 hour forecast from the preceding forecast cycle.

10. A numerical weather model generation method according to claim 8, wherein the existing full resolution weather model is the final (FNL) GFS forecast from the preceding forecast cycle.

11. A numerical weather model generation method according to claim 1, wherein the extended forecast period is more than 3 days.

12. A numerical weather model generation method according to claim 1, wherein the extended forecast period is more than 6 days.

13. A numerical weather model generation method according to claim 1, wherein the extended forecast period is a 16 day forecast.

14. A numerical weather model generation method according to claim 1, wherein the resolution of the existing full resolution global coverage weather model is reduced prior to compiling the received weather observation data in the memory with the stored existing full resolution global coverage weather model to represent conditions in the atmosphere.

15. A numerical weather model generation method according to claim 14, wherein the resolution of the existing full resolution global coverage weather model is reduced to substantially the same resolution level as the resolution level used in the accelerated global coverage weather model.

16. A numerical weather model generation method according to claim 1, wherein the mandated observation period is the data cut off time used by the NCEP GFS model forecast.

17. A numerical weather model generation method according to claim 1, wherein the mandated observation period is about 2 hours and 45 minutes.

18. A method of determining likely changes in a forecast weather model executed by a computer under the control of a program, said method comprising:
a) storing an existing full resolution global coverage weather model in a memory;
b) receiving weather observation data from a plurality of globally located weather observation points for less than a mandated observation period;
c) generating a numerical representation of atmospheric conditions based on the received weather observation data and the full resolution global coverage weather model;
d) generating an accelerated global coverage weather model for an extended forecast period based in part on the generated numerical representation of the atmospheric conditions while using a resolution value less than a resolution value used to generate the existing full resolution global coverage weather model;
e) comparing the accelerated global coverage weather model to the existing full resolution global coverage weather model; and
f) generating a report representing the likely changes in the full resolution global coverage weather model.

19. A method of determining likely changes in a forecast weather model according to claim 18 wherein the existing full resolution global coverage weather model is based on the National Center Environmental Prediction (NCEP) Global Forecast System (GFS) model.

20. A method of determining likely changes in a forecast weather model according to claim 19 wherein the existing full resolution weather model is the forecast weather model from the preceding forecast cycle valid for the nominal observation time of the current forecast cycle.

21. A method of determining likely changes in a forecast weather model according to claim 19 wherein the existing full resolution weather model is the final GFS (GFS FNL) forecast from the preceding forecast cycle.

22. A method of determining likely changes in a forecast weather model according to claim 19 wherein the step of generating a numerical representation of atmospheric conditions based on the received weather observation data and the full resolution global coverage weather model further comprises disregarding some global weather observations received before the nominal observation time.

23. A method of determining likely changes in a forecast weather model according to claim 22 wherein the remaining number of global weather observations received before the nominal observation time are of about the same number and type of global weather observations received after the nominal observation time.

24. A method of determining likely changes in a forecast weather model according to claim 18 wherein the existing full resolution global coverage weather model and the accelerated global coverage weather model are both spectral weather models.

25. A method of determining likely changes in a forecast weather model according to claim 24 wherein the resolution value is both spectral resolution and vertical resolution.

26. A method of determining likely changes in a forecast weather model according to claim 18 wherein the existing full resolution global coverage weather model and the accelerated global coverage weather model are both finite difference weather models.

27. A method of determining likely changes in a forecast weather model according to claim 26 wherein the resolution value is both grid point spacing and vertical resolution.

28. A method of determining likely changes in a forecast weather model according to claim 18 wherein the step of comparing the accelerated global coverage weather model to the existing full resolution global coverage weather model further comprises comparing a generated graphical output of a forecasted variable from the existing full resolution global coverage weather model to a corresponding generated graphical output for the same forecasted variable from the accelerated global coverage weather model.

29. A method of determining likely changes in a forecast weather model according to claim 28 wherein the generated graphical output of a forecasted variable is selected from the group consisting of: temperature, humidity, geopotential height, heat index, wind speed, pressure, and precipitation.

30. A method of determining likely changes in a forecast weather model according to claim 28 wherein the step of generating a report representing the likely changes in the full resolution global coverage weather model further comprises a computer generated visual indication of an increase in a forecast variable, a computer generated visual indication of a decrease in a forecast variable, a computer generated visual indication of the magnitude of an increase in a forecast variable, and a computer generated visual indication of the magnitude of a decrease in a forecast variable.

31. A method of determinining likely changes in a forecast weather model according to claim 18 wherein the report representing the likely changes in the full resolution global coverage weather model utilizes the same computational array as the full resolution global coverage weather model.

32. A method of determining likely changes in a forecast weather model according to claim 31 wherein the computational array is wave number.

33. A method of determining likely changes in a forecast weather model according to claim 31 wherein the computational array is grid points.

34. A computer readable medium, comprising:
(a) executable instructions to generate a displayed geographic location;
(b) executable instructions to generate a forecast duration having a plurality of subdivided time periods; wherein, for the geographic location during each of the subdivided time periods there is provided at least one of a computer generated visual indication of an increase in a forecast variable, a computer generated visual indication of a decrease in a forecast variable, a computer generated visual indication of the magnitude of an increase in a forecast variable, and a computer generated visual indication of the magnitude of a decrease in a forecast variable.

35. The computer readable medium of claim 34, wherein the forecasted weather variable is selected from the group consisting of: temperature, atmospheric thickness, humidity, geopotential height, heat index, wind speed, pressure, and precipitation.

36. The computer readable medium of claim 34, wherein the forecast duration is greater than 3 days.

37. The computer readable medium of claim 34, wherein the forecast duration is less than 16 days.

38. The computer readable medium of claim 34, wherein the forecast duration is 16 days.

39. The computer readable medium of claim 38, wherein the plurality subdivided time periods is one day.

40. The computer readable medium of claim 34, wherein for the geographic location during each of the subdivided time periods there is provided an indicator signifying the confidence level in the at least one of a computer generated visual indication of an increase in a forecast variable, a computer generated visual indication of a decrease in a forecast variable, a computer generated visual indication of an increase in a forecast variable, a computer generated visual indication of the magnitude of an increase in a forecast variable, and a computer generated visual indication of the magnitude of a decrease in a forecast variable.

41. The computer readable medium of claim 34, wherein the weather forecast variable and geographic location are selected by a user remotely accessing the computer being used to generate the computer generated visual display of a weather forecast variable.

42. A method for determining a trading position in a financial market, the method comprising:
(a) generating a computer-based accelerated global coverage weather model of a full resolution global coverage weather model, the full resolution global coverage weather model representing the index of market consensus for the weather forecast;
(b) producing an output representing the likely changes in the full resolution global coverage weather model by comparing the accelerated global coverage weather model to the full resolution global coverage weather model; and
(c) adjusting a trading position of a trading instrument based upon the output representing the likely changes in the full resolution global coverage weather model.

43. A method for determining a trading position in a financial market according to claim 42 wherein the output representing the likely change in the full resolution global coverage weather model includes likely changes in a forecasted weather variable.

44. A method for determining a trading position in a financial market according to claim 43 wherein the forecasted weather variable is selected from the group consisting of: temperature, humidity, geopotential height, heat index, atmospheric thickness, wind speed, pressure, and precipitation.

45. A method for determining a trading position in a financial market according to claim 42 wherein the trading instrument is physical and the trading commodity is selected from the group consisting of: electricity, natural gas, heating oil, and agricultural products.

46. A method for determining a trading position in a financial market according to claim 42 wherein the trading instrument is financial and the trading commodity is selected from the group consisting of: electricity, natural gas, heating oil, and agricultural products.

47. A method for determining a trading position in a financial market according to claim 42 wherein adjusting a trading position of a trading instrument based upon the output representing the likely changes in the full resolution global coverage weather model is performed before a scheduled update to the index of market consensus for the weather forecast is generally available.

48. A method for determining a trading position in a financial market according to claim 42 wherein the generating is initiated such that the adjusting is performed during the trading hours of a financial market of interest.

49. A method for determining a trading position in a financial market according to claim 42, wherein the generating further comprises:
a) storing an existing full resolution global coverage weather model in a memory;
b) receiving a plurality of global weather observation data for less than a mandated observation period;
c) compiling the received weather observation data in the memory with the stored existing full resolution global coverage weather model to represent conditions in the atmosphere; and
d) generating an accelerated global coverage weather model for an extended forecast period based in part on the received weather observation data using a resolution value less detailed than a resolution value used to generate the existing full resolution global coverage weather model.
